(19) United States
(12) Patent Application Publication
(10) Pub. No.: US 2026/0191177 A1
(43) Pub. Date: Jul. 9, 2026

(54) AMMUNITION COMPONENTS BASED FISHING LURES

(71) Applicant: Porter Kraft, Mapleton, UT (US)

(72) Inventor: Porter Kraft, Mapleton, UT (US)

(21) Appl. No.: 19/014,170

(22) Filed: Jan. 8, 2025

(51) Int. Cl. A01K 85/10; A01K 83/00; A01K 85/00; A01K 85/01

(52) U.S. Cl. CPC A01K 85/10; A01K 83/00; A01K 85/013; A01K 85/1837; A01K 85/1841; A01K 85/1847

(57) ABSTRACT

A plurality of fishing lures manufactured from firearm ammunition components is disclosed in this specification. Each lure comprises at least a body and at least one hook. The body of each lure comprises one or more firearm ammunition components wherein the lure is configured to look similar to other kinds of fishing lures with the unique aspect of at least a portion of each lure being manufactured from firearm ammunition components. The lures may be painted or fitted with other elements (connecting loops, spinners, hair, shiny sequins, etc.) specifically designed and configured so as to attract one or more specific species of fish. Finally, in accordance with other preferred embodiments of the present invention, a method for manufacturing fishing lures using firearm ammunition components is disclosed.

### BACKGROUND OF THE INVENTION

### 1. Technical Field

The present invention relates generally to sporting goods and more particularly relates to a unique design and functionality for fishing lures.

### 2. Background Art

Fishing is one of the most popular outdoor activities worldwide, enjoyed by millions for its blend of relaxation, challenge, and connection with nature. Whether casting a line in a quiet stream, trolling in a vast ocean, or ice fishing on a frozen lake, the pursuit of fish has long been a way to unwind, enjoy the outdoors, and even provide sustenance. It's a pastime that transcends generations, with people from all walks of life taking to the water in search of that perfect catch. The simplicity of fishing, coupled with the thrill of reeling in a big one, makes it an enduring and cherished hobby.

One of the most common methods of fishing involves using lures, which are artificial baits designed to attract fish. Lures come in a variety of shapes, sizes, colors, and materials, each tailored to mimic the appearance and movement of different types of prey that fish naturally seek. Some lures are designed to resemble small fish, while others mimic insects, worms, or even frogs. Anglers select lures based on the species of fish they are targeting, the water conditions, and the time of year. The art of choosing the right lure involves understanding the behavior of the fish, making lure selection both a science and a skill.

However, using lures in fishing has its challenges. One of the primary issues is that lures can be expensive, and they often get lost or damaged, especially when fishing in areas with heavy vegetation or rocky bottoms. Additionally, not all fish are equally attracted to artificial lures, making it necessary to carry a variety of lures to increase the chances of success. Some fish may even become “lure shy,” especially in heavily fished waters where they have learned to avoid certain types of lures. Despite these challenges, many anglers find the use of lures to be a rewarding aspect of fishing, as it allows for a more active and strategic approach to catching fish.

Professional and hobbyist anglers are always looking for new and innovative options when selecting fishing lures so as to overcome the drawbacks of the existing lures and to create additional interest in the sport because better lures means more success in fishing. Accordingly, additional improvements in the state of the art for fishing lures is always an important consideration.

### SUMMARY OF THE INVENTION

In accordance with the most preferred embodiments of the present invention, A plurality of fishing lures manufactured from firearm ammunition components is disclosed in this specification. Each lure comprises at least a body and at least one hook. The body of each lure comprises one or more firearm ammunition components wherein the lure is configured to look similar to other kinds of fishing lures with the unique aspect of at least a portion of each lure being manufactured from firearm ammunition components. The lures may be painted or fitted with other elements (connecting loops, beads, spinners, hair, shiny sequins, etc.) specifically designed and configured so as to attract one or more specific species of fish. Finally, in accordance with other preferred embodiments of the present invention, a method for manufacturing fishing lures using firearm ammunition components is disclosed.

### BRIEF DESCRIPTION OF DRAWINGS

The preferred embodiments of the present invention will hereinafter be described in conjunction with the appended drawings, wherein like designations denote like elements, and:

FIG. 1 is a view of a fishing lure in accordance with a preferred exemplary embodiment of the present invention;

FIG. 2 is a view of a fishing lure in accordance with an alternative preferred exemplary embodiment of the present invention;

FIG. 3 is a view of a fishing lure in accordance with an alternative preferred exemplary embodiment of the present invention;

FIG. 4 is a view of a fishing lure in accordance with an alternative preferred exemplary embodiment of the present invention; and

FIG. 5 is a flow chart for a method of providing a fishing lure in accordance with a preferred exemplary embodiment of the present invention.

### DETAILED DESCRIPTION OF THE INVENTION

A plurality of fishing lures manufactured from firearm ammunition components is disclosed in this specification. Each lure comprises at least a body and at least one hook. The body of each lure comprises one or more firearm ammunition components wherein the lure is configured to look similar to other kinds of fishing lures with the unique aspect of at least a portion of each lure being manufactured from firearm ammunition components. The lures may be painted or fitted with other elements (connecting loops, spinners, hair, shiny sequins, etc.) specifically designed and configured so as to attract one or more specific species of fish. Finally, in accordance with other preferred embodiments of the present invention, a method for manufacturing fishing lures using firearm ammunition components is disclosed.

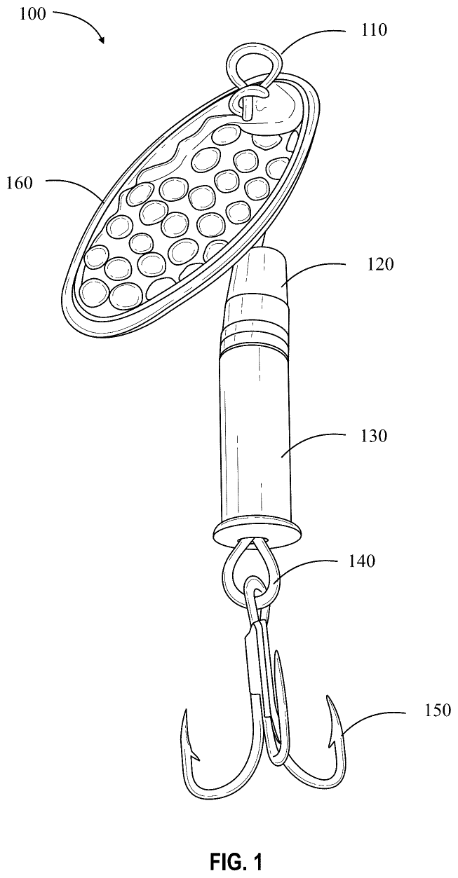

Referring now to FIG. 1, a fishing lure 100 in accordance with a preferred exemplary embodiment of the present invention is depicted. As shown in FIG. 1, fishing lure 100 comprises: a connector 110; a bullet 120; a casing 130; a connector 140; one or more hooks 150; and at least one spinner 160.

Connector 110 comprises any suitable connector that can be used to connect fishing lure 100 to a fishing line or other fishing tackle suitable to use lure 100 for casting or trolling. Suitable components might include swivels, snap swivels, eye hook connectors, wires, etc. These items are only some of the potential types of connectors that may be used and many other connectors known to those skilled in the art may be successfully employed.

Bullet 120 most preferably comprises a standard lead, iron, or other metallic bullet used in pistol and rifle cartridges. Those skilled in the art will recognize that some preferred embodiments of bullet 120 may be manufactured from plastics as well as other materials.

Casing 130 is most typically manufactured from brass or steel although other manufacturing materials may be used. In a standard ammunition environment, casing 130 will contain gunpowder or other explosive substance and a primer, used to ignite the gunpowder, will be inserted into the end of casing 130, where connector 140 is positioned. However, in the present invention, no explosive materials or primers are included with casing 130 and casing 130 will be hollow or contain some kind of ballast for creating a lure 100 suitable for a specific fishing activity or species of fish.

Connector 140 is inserted into or affixed to casing 130 by welding or screwing or other suitable attachment means and is used to attach one or more hooks 150 to casing 130. Connector 140 comprises any suitable connector that can be used to connect fishing lure 100 to hooks 150. Suitable components might include swivel hooks, snap swivels, eye hook connectors, wires, etc. These items are only some of the potential types of connectors that may be used and many other connectors known to those skilled in the art may be successfully employed.

Hooks 150 may be any type of hook known to those skilled in the art. Hooks 150 are typically manufactured from metal and comprise one or more barbs positioned at the end of each of the arms for hooks 150. Although hooks 150 comprise a treble hook, those skilled in the art will recognize that many other hooks, including single hooks or double hooks, may be used for the same function as hooks 1850.

Spinner 160 typically comprises a decorative element manufactured from plastic or metal materials and is configured to draw the attention of a fish towards lure 100. As lure 100 is pulled through the water, spinner 160 will rotate in a circular motion. The surface of spinner 160 may comprise a series of dimples, wave, reflective material, etc. so as to attract attention from a fish and draw the fish towards lure 100. Spinner 160 is completely optional and at least some preferred embodiments of the present invention will not include a spinner 160.

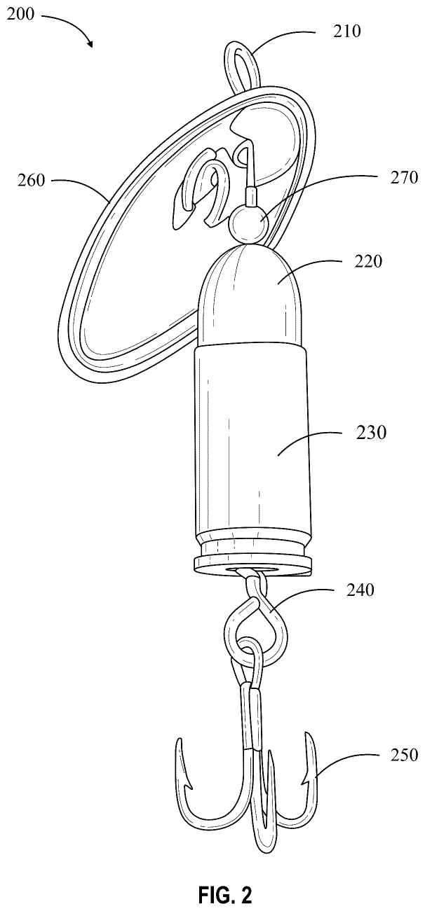

Referring now to FIG. 2, a fishing lure 200 in accordance with an alternative preferred exemplary embodiment of the present invention is depicted. As shown in FIG. 2, fishing lure 200 comprises: a connector 210; a bullet 220; a casing 230; a connector 240; one or more hooks 250; at least one spinner 260; and at least one bead 270.

Connector 210 comprises any suitable connector that can be used to connect fishing lure 210 to a fishing line or other fishing tackle suitable to use lure 200 for casting or trolling. Suitable components might include swivels, snap swivels, eye hook connectors, wires, etc. These items are only some of the potential types of connectors that may be used and many other connectors known to those skilled in the art may be successfully employed.

Bullet 220 preferably comprises a standard lead, iron, or other metallic bullet used in pistol and rifle cartridges. Those skilled in the art will recognize that some preferred embodiments of bullet 220 may be manufactured from plastics as well as other materials.

Casing 230 is most typically manufactured from brass or steel although other manufacturing materials may be used. In a standard ammunition environment, casing 130 will contain gunpowder or other explosive substance and a primer, used to ignite the gunpowder, will be inserted into the end of casing 230, where connector 240 is positioned. However, in the present invention, no explosive materials or primers are included with casing 230 and casing 230 will be hollow or contain some kind of ballast for creating a lure 200 suitable for a specific fishing activity or species of fish. In addition, casing 230 may be any color suitable for the desired effect and may be painted, manufactured from a colored material, etc.

Connector 240 is inserted into or attached to casing 230 by welding or screwing or other suitable attachment means and is used to attach one or more hooks 250 to casing 230. Connector 240 comprises any suitable connector that can be used to connect fishing lure 200 to hooks 250. Suitable components might include swivel hooks, snap swivels, eye hook connectors, wires, etc. These items are only some of the potential types of connectors that may be used and many other connectors known to those skilled in the art may be successfully employed.

Hooks 250 may be any type of hook known to those skilled in the art. Hooks 250 are typically manufactured from metal and comprise one or more barbs positioned at the end of each of the arms for hooks 250. Although hooks 250 comprise a treble hook, those skilled in the art will recognize that many other hooks, including single hooks or double hooks, may be used for the same function as hooks 250.

Spinner 260 typically comprises a decorative element manufactured from plastic or metal materials and is configured to draw the attention of a fish towards lure 200. As lure 200 is pulled through the water, spinner 260 will rotate in a circular motion. The surface of spinner 260 may comprise a series of dimples, wave, reflective material, etc. so as to attract attention from a fish and draw the fish towards lure 200.

Bead 270 comprises a decorative element that is typically positioned on connector 210. Bead 270 may be manufactured from plastic, glass, or other suitable material and comprises a decorative element designed to attract fish to lure 200. Bead 270 may be colored, shiny, and/or reflective so as to attract the desired species of fish.

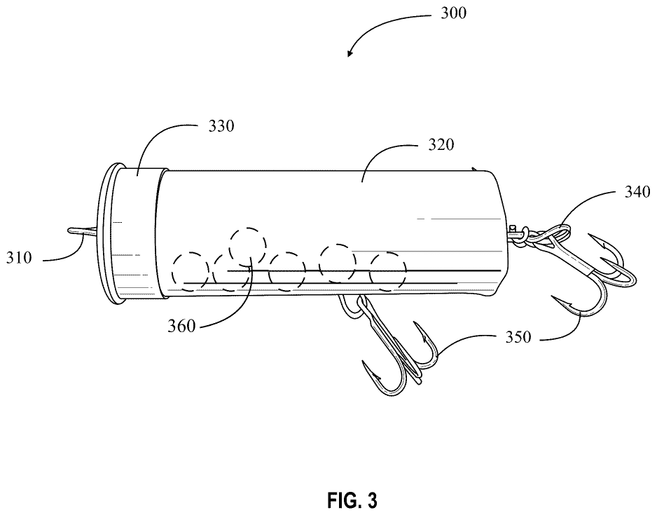

Referring now to FIG. 3, a fishing lure 300 in accordance with an alternative preferred exemplary embodiment of the present invention is depicted. As shown in FIG. 3, fishing lure 300 comprises ammunition components commonly used in standard shot gun ammunition. In this case, fishing lure 300 comprises: a connector 310; a casing 320; head 330; a connector 340; and one or more hooks 350. In addition, in certain preferred embodiments of the present invention, ballast 360 in the form of lead weights or other similar material may be contained within casing 320 to add an appropriate amount of weight to fishing lure 300 to ensure that fishing lure 300 reaches the desired depth when casting or trolling.

Connector 310 comprises any suitable connector that can be used to connect fishing lure 300 to a fishing line or other fishing tackle suitable to use lure 300 for casting or trolling. Suitable components might include swivels, snap swivels, eye hook connectors, wires, etc. These items are only some of the potential types of connectors that may be used and many other connectors known to those skilled in the art may be successfully employed.

In FIG. 3, casing 320 comprises a casing from a standard shot gun load with a caliber of 12 gauge, 20 gauge, .410 gauge or other similar type of casing. Casing 320 may be a casing from a spent shell that has been reclaimed and recycled or a newly manufactured casing.

Head 330 generally serves as a connection point for attachment of connector 310 to casing 320.

Connector 340 is inserted into or affixed to casing 320 and is used to attach one or more hooks 350 to casing 320. Connector 340 comprises any suitable connector that can be used to connect fishing lure 300 to hooks 350. Suitable components might include swivel hooks, snap swivels, eye hook connectors, wires, etc. These items are only some of the potential types of connectors that may be used and many other connectors known to those skilled in the art may be successfully employed.

Hooks 350 may be any type of hook known to those skilled in the art. Hooks 350 are typically manufactured from metal and comprise one or more barbs positioned at the end of each of the arms for hooks 350. Although hooks 350 comprise a treble hook, those skilled in the art will recognize that many other hooks, including single hooks or double hooks, may be used for the same function as hooks 350.

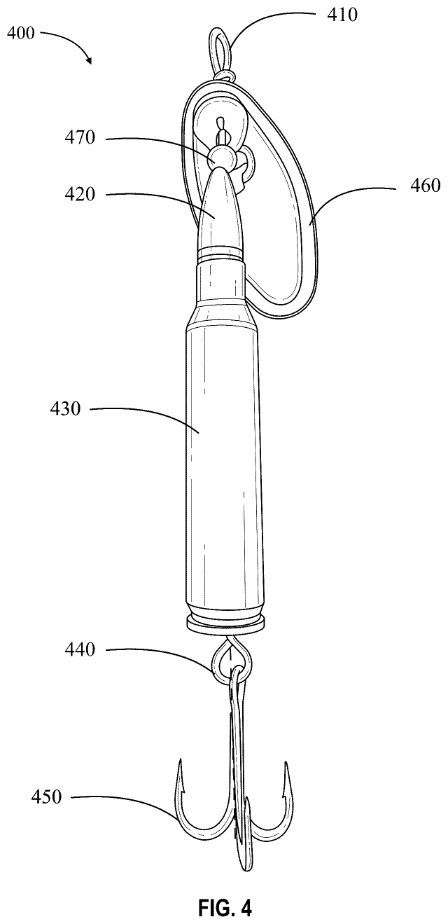

Referring now to FIG. 4, a fishing lure 400 in accordance with an alternative preferred exemplary embodiment of the present invention is depicted. As shown in FIG. 4, fishing lure 400 comprises: a connector 410; a bullet 420; a casing 430; a connector 440; one or more hooks 450; at least one spinner 460; and at least one bead 470. In the case of fishing lure 400, bullet 420 and casing 430 comprises a the casing for a typical round of ammunition in a caliber such as 5.56 or .223.

Connector 410 comprises any suitable connector that can be used to connect fishing lure 400 to a fishing line or other fishing tackle suitable to use lure 400 for casting or trolling. Suitable components might include swivels, snap swivels, eye hook connectors, wires, etc. These items are only some of the potential types of connectors that may be used and many other connectors known to those skilled in the art may be successfully employed.

Bullet 420 preferably comprises a standard lead, iron, or other metallic bullet used in pistol and rifle cartridges. Those skilled in the art will recognize that some preferred embodiments of bullet 120 may be manufactured from plastics as well as other materials.

Casing 430 is a casing for a round of ammunition and is most typically manufactured from brass or steel although other manufacturing materials may be used. In a standard ammunition environment, casing 430 will contain gunpowder or other explosive substance and a primer, used to ignite the gunpowder, will be inserted into the end of casing 430, where connector 440 is positioned. However, in the present invention, no explosive materials or primers are included with casing 430 and casing 430 will be hollow or contain some kind of ballast for creating a lure 400 suitable for a specific fishing activity or species of fish.

Connector 440 is inserted into or affixed to casing 430 by welding or screwing or other suitable attachment means and is used to attach one or more hooks 450 to casing 430. Connector 440 comprises any suitable connector that can be used to connect fishing lure 400 to hooks 450. Suitable components might include swivel hooks, snap swivels, eye hook connectors, wires, etc. These items are only some of the potential types of connectors that may be used and many other connectors known to those skilled in the art may be successfully employed

Hooks 450 may be any type of hook known to those skilled in the art. Hooks 450 are typically manufactured from metal and comprise one or more barbs positioned at the end of each of the arms for hooks 450. Although hooks 450 comprise a treble hook, those skilled in the art will recognize that many other hooks, including single hooks or double hooks, may be used for the same function as hooks 450.

Spinner 460 typically comprises a decorative element manufactured from plastic or metal materials and is configured to draw the attention of a fish towards lure 400. As lure 400 is pulled through the water, spinner 460 will rotate in a circular motion. The surface of spinner 460 may comprise a series of dimples, wave, reflective material, etc. so as to attract attention from a fish and draw the fish towards lure 400.

Bead 470 comprises a decorative element that is typically positioned on connector 410. Bead 470 may be manufactured from plastic, glass, or other suitable material and comprises a decorative element designed to attract fish to lure 400. Bead 470 may be colored, shiny, and/or reflective so as to attract the desired species of fish.

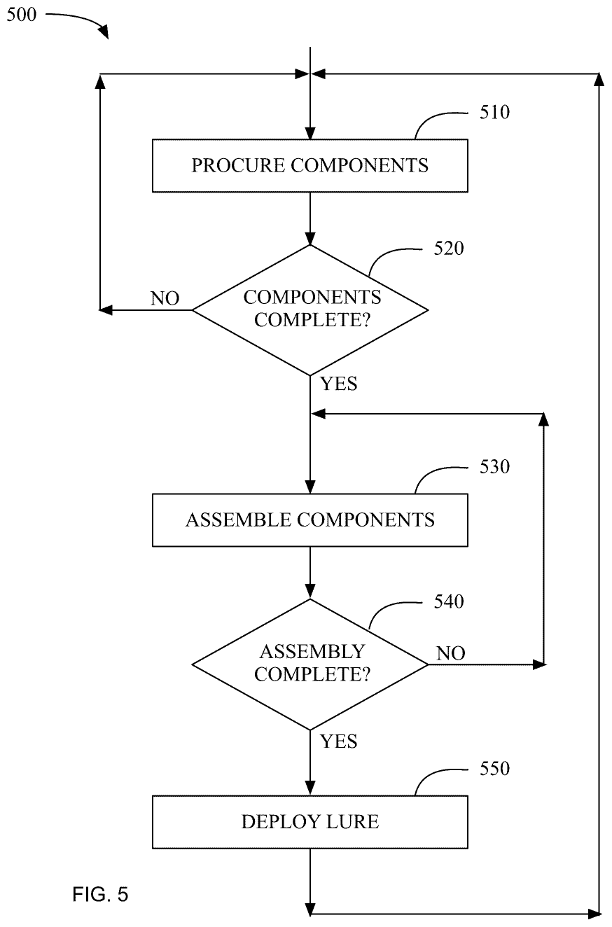

Referring now to FIG. 5, a flowchart for a method 500 of providing a fishing lure in accordance with a preferred exemplary embodiment of the present invention is depicted. As shown in FIG. 5, components for the fishing lure are procured (STEP 510). As discussed above, these components comprise various components that are typically used to manufacture ammunition. The components may be newly manufactured components or spent components from ammunition that has been recovered and recycled.

Once the desired number and type of components have been procured (STEP 520=“YES”), the components can be assembled (STEP 530) into a fishing lure. If the desired number and type of components have not been procured (STEP 520=“NO”), the process of procuring components will continue (STEP 510).

Once the assembly of the lure has been completed (STEP 540=“YES”) then the lure can be deployed (STEP 550) and the steps can be completed again to create additional lures as desired. If the assembly of components have not been completed, (STEP 540=“NO”), the process of assembling components will continue (STEP 530).

By using method 500, the desired number and variety of fishing lures in accordance with the preferred exemplary embodiments of the present invention can be provided. Those skilled in the art will recognize that the variations are practically numberless and no limitation of the types of fishing lures is intended by the provision of the exemplary embodiments with the scope of the invention being constrained only by the language of the claims. For example, for each caliber of ammunition, an appropriate fishing lure may be constructed. Each fishing lure may have any number of spinners, beads, hair, etc. in any combination.

Additionally, unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term.

Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”), provided herein is intended merely to better illuminate the present disclosure and does not pose a limitation on the scope of the embodiments otherwise claimed. No language in the present specification should be construed as indicating any non-claimed element essential to the practice of the disclosed embodiments.

1. A fishing lure comprising:
a bullet;
a casing for a round of ammunition connected to a first portion of the bullet;
a first connector coupled to a second portion of the bullet;
a second connector coupled to the casing opposite the bullet; and
at least one hook coupled to the second connector.

2. The fishing lure of claim 1 further comprising at least one decorative spinner positioned between the first connector and the bullet.

3. The fishing lure of claim 1 further comprising at least one decorative bead positioned between the first connector and the bullet.

4. The fishing lure of claim 1 further comprising at least one decorative spinner positioned between the first connector and the bullet; the decorative spinner comprising a surface, wherein the surface comprises a reflective material and the surface further comprises at least one of a dimple and one wave.

5. The fishing lure of claim 1 wherein the casing is one of a spent casing and a recycled casing.

6. The fishing lure of claim 1 further comprising:
at least one decorative bead positioned between the first connector and the bullet;
at least one decorative bead positioned between the first connector and the bullet; and
a surface, wherein the surface comprises a reflective material and the surface comprises at least one dimple or one wave.

7. The fishing lure of claim 1 wherein the at least one hook comprises a treble hook.

8. The fishing lure of claim 1 wherein the casing comprises a casing for a typical round of ammunition for a caliber selected from the group of:.22; 9 mm; 5.56; or .223, .45 ACP.

9. The fishing lure of claim 1 further comprising:
at least one decorative bead positioned between the first connector and the bullet;
at least one decorative spinner positioned between the first connector and the bullet;
a surface on the spinner, wherein the surface comprises a reflective material and the surface comprises at least one dimple or one wave;
at least one hook positioned affixed to the second connector; and
wherein the casing comprises a casing for a typical round of ammunition for a caliber selected from the group of: .22; 9 mm; 5.56; .223, or .45 ACP.

10. A method of constructing a fishing lure, the method comprising the steps of:
gathering a plurality of components, the plurality of components comprising:
a first connector;
a bullet;
a casing for a round of ammunition;
a second connector; and
at least one hook coupled to the second connector;
attaching the first connector to the bullet;
attaching the bullet to the casing;
attaching the second connector to the casing opposite the bullet; and
attaching the hook to the second connector.

11. The method of claim 10, further comprising the step of positioning at least one decorative bead between the first connector and the bullet.

12. The method of claim 10, further comprising the step of positioning at least one decorative spinner between the first connector and the bullet.

13. The method of claim 10 wherein the casing comprises a casing for a typical round of ammunition for a caliber selected from the group of: .22; 9 mm; 5.56; .223; or .45 ACP.

14. The method of claim 10 wherein the hook comprises a treble hook.

15. The method of claim 10, further comprising the steps of:
positioning at least one decorative bead between the first connector and the bullet;
positioning at least one decorative spinner between the first connector and the bullet, the at least one decorative spinner comprising a surface, the surface comprising at least one of a dimple and a wave; and
wherein the casing comprises a casing for a typical round of ammunition for a caliber selected from the group of: .22; 9 mm; 5.56; .223; or .45 ACP.

16. A fishing lure comprising:
a first connector, the first connector comprising a snap swivel;
a bullet;
a casing for a round of ammunition, the casing comprises a casing for a typical round of ammunition for a caliber selected from the group of: .22; 9 mm; 5.56; .223; or .45 ACP, the casing being connected to the bullet;
a second connector, the second connector comprising a snap swivel;
at least one decorative spinner positioned between the first connector and the bullet, the at least one decorative spinner comprising a surface, the surface comprising at least one of a dimple and a wave;
at least one decorative bead positioned between the first connector and the bullet; and
at least one treble hook affixed to the second connector.
